(19) United States
(12) Patent Application Publication
(10) Pub. No.: US 2025/0237269 A1
(43) Pub. Date: Jul. 24, 2025

(54) SPLINE CONNECTION STRUCTURE

(71) Applicant: TOYOTA JIDOSHA KABUSHIKI KAISHA, Toyota-shi (JP)

(72) Inventor: Nobuharu IMAI, Toyota-shi (JP)

(73) Assignee: TOYOTA JIDOSHA KABUSHIKI KAISHA, Toyota-shi (JP)

(21) Appl. No.: 19/017,996

(22) Filed: Jan. 13, 2025

(30) Foreign Application Priority Data
Jan. 23, 2024 (JP) 2024-008330

(51) Int. Cl. F16D 3/12; F16D 3/06

(52) U.S. Cl. CPC F16D 3/12; F16D 3/06

(57) ABSTRACT

A spline connection structure for connecting between a drive shaft and a side gear of a differential gear device through spline engagement. The spline connection structure includes: outer spline teeth provided on an outer circumferential surface of the drive shaft; and inner spline teeth provided on an inner circumferential surface of the side gear. At least one of the outer spline teeth of the drive shaft is absent. The spline connection structure further includes a rod-shaped elastic body provided in a longitudinal space that is formed by absence of each of the at least one of the outer spline teeth of the drive shaft. Also disclosed is a process of connecting between the drive shaft and the side gear by the spline connection structure.

This application claims priority from Japanese Patent Application No. 2024-008330 filed on Jan. 23, 2024, the disclosure of which is herein incorporated by reference in its entirety.

### FIELD OF THE INVENTION

The present invention relates to a connection structure for connecting between a differential gear device provided in a vehicle and a drive shaft connected to a wheel of the vehicle.

### BACKGROUND OF THE INVENTION

In a differential gear device provided in a vehicle, a side gear of the differential gear device and a drive shaft are connected to each other by spline engagement. There is a gap between inner spline teeth provided on an inner circumferential surface of the side gear and outer spline teeth provided on an outer circumferential surface of the drive shaft. Therefore, for example, when torque inputted from an engine to the differential gear device and transmitted to the drive shaft is changed, a shock or a time lag occurs upon acceleration or deceleration of the vehicle due to backlash in the spline engagement between the side gear and the drive shaft. As a countermeasure, Patent Document 1 discloses a technique in which, after the spline engagement has been established, a wedge-shaped screw, which has been inserted into the drive shaft, is tightened by a screw driver tool introduced through a work opening provided in the differential gear device, so as to increase an outside diameter of an inside end portion of the drive shaft, thereby achieving fitting of the side gear and the drive shaft in a just-fitting state (without interference fitting) or a tight-fitting state (with interference fitting).

### PRIOR ART DOCUMENT

### Patent Document

### [Patent Document 1]

Japanese Patent Application Laid-Open No. 2007-292121

### SUMMARY OF THE INVENTION

The countermeasure described in Patent Document 1 is to increase the outside diameter of the inside end portion of the drive shaft, and therefore, tooth surfaces of the spline teeth are in local contact at their inside end portions with each other. Further, since the inside end portions of the tooth surfaces are easily worn, there is a problem that backlash between the side gear and the drive shaft is easily increased even in the in the just-fitting state or tight-fitting state.

The present invention has been made in view of the above circumstances, and an object of the present invention is to provide a spline connection structure for a differential gear device, wherein the spline connection structure has high durability and is capable of reducing backlash in its spline engagement.

The present invention provides a spline connection structure for connecting between a drive shaft and a side gear of a differential gear device through spline engagement. The spline connection structure includes: outer spline teeth provided on an outer circumferential surface of the drive shaft; and inner spline teeth provided on an inner circumferential surface of the side gear. At least one of the outer spline teeth of the drive shaft is absent. The spline connection structure further includes a rod-shaped elastic body provided in a longitudinal space that is formed by absence of each of the at least one of the outer spline teeth of the drive shaft.

In the spline connection structure according to the present invention, the at least one of the outer spline teeth of the drive shaft is absent, and the rod-shaped elastic body is provided in the longitudinal space that is formed by absence of each of the at least one of the outer spline teeth of the drive shaft. Thus, backlash of the spline engagement between the inner spline teeth of the side gear and the outer spline teeth of the drive shaft is eliminated or reduced by elastic force based on spring characteristics of the rod-shaped elastic body, wherein the elastic force acts, for example, in a radial direction or a circumferential direction of the drive shaft. Therefore, it is possible to obtain the spline connection structure having high durability and capable of reducing the backlash in its spline engagement.

### BRIEF DESCRIPTION OF THE DRAWINGS

FIG. 1 is a view illustrating an example of a schematic construction of a vehicle to which the present invention is applied.

FIG. 2 is a view for explaining an example of a construction of a differential gear device, and is a view showing an example of a state before the differential gear device and a drive shaft are assembled.

FIG. 3 is a set of views for explaining an example of a spline connection structure to which the present invention is applied.

FIGS. 4A and 4B are views illustrating examples of spring characteristics of rod-shaped elastic bodies.

FIGS. 5A-5D are views for explaining examples of arrangement of the rod-shaped elastic bodies.

FIG. 6 is a set of views for explaining another embodiment of a spline connection structure to which the present invention is applied.

### DETAILED DESCRIPTION OF PREFERRED EMBODIMENTS

Hereinafter, embodiments of the invention will be described in detail with reference to the accompanying drawings. In the following embodiments, the drawings are simplified or modified as appropriate, and the dimensional ratios, shapes, and the like of the respective parts are not necessarily accurately drawn.

### First Embodiment

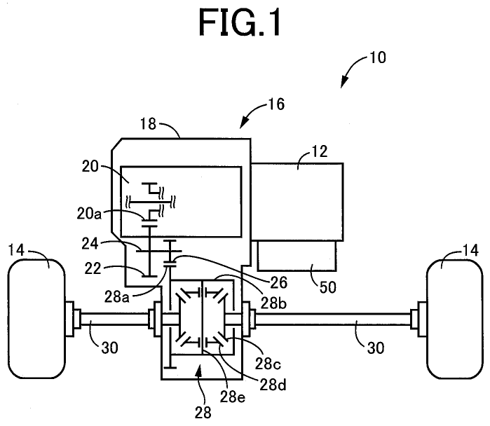

FIG. 1 is a view illustrating a schematic construction of a vehicle 10 to which the present invention is applied. As shown in FIG. 1, the vehicle 10 includes an engine 12 as a power source, drive wheels 14, a power transmission device 16 provided in a power transmission path between the engine 12 and the drive wheels 14.

The engine 12 is a known internal combustion engine, and an engine torque Te, which is a torque of the engine 12, is controlled by an engine control device 50 including a fuel injection device and the like provided in the vehicle 10.

The power transmission device 16 is disposed in a non-rotatable casing 18 attached to a body of the vehicle 10. The power transmission device 16 includes a transmission unit 20, a driven gear 22, a driven shaft 24, a final gear 26 and a differential gear device 28. The differential gear device 28 is a gear device including a differential ring gear 28a, a differential casing 28b, a pair of side gears 28c, a pair of differential pinions 28d and a pinion shaft 28e. A pair of right and left drive shafts 30 are connected to the differential gear device 28. The “right and left” are right and left with respect to a forward running direction of the vehicle 10.

The transmission unit 20 is connected to the engine 12. The driven gear 22 meshes with a drive gear 20a, which is an output rotary member of the transmission unit 20. The driven gear 22 and the final gear 26 are mounted on the driven shaft 24 so as not to be rotatable relative to each other. The final gear 26 has a smaller diameter than the driven gear 22, and meshes with the differential ring gear 28a. The differential ring gear 28a is an input rotary member of the differential gear device 28. The differential gear device 28 distributes power from the engine 12 to the right and left drive wheels 14.

The power transmission device 16 transmits the power outputted from the engine 12 to the driven gear 22 via the transmission unit 20. The power transmission device 16 transmits the power transmitted to the driven gear 22 to the right and left drive wheels 14 sequentially via the driven shaft 24, the final gear 26, the differential gear device 28 and the right and left drive shafts 30, for example.

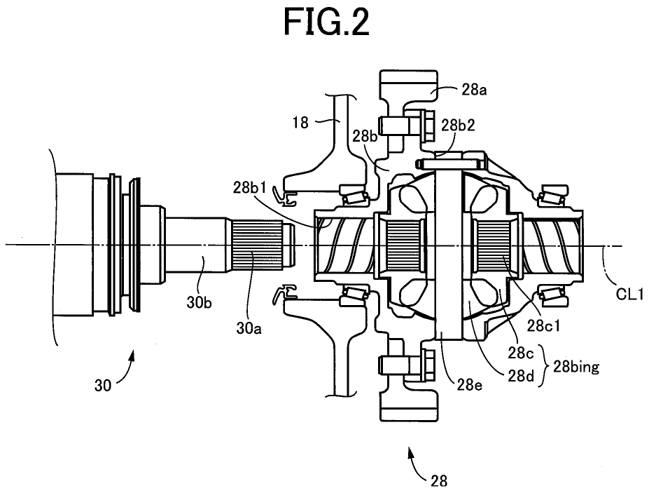

FIG. 2 is a view illustrating an example of the construction of the differential gear device 28. FIG. 2 is a view showing an example of a state before the differential gear device 28 and the drive shafts 30 are assembled. As shown in FIG. 2, the differential gear device 28 includes the differential casing 28b. The pair of side gears 28c, the pair of differential pinions 28d and the pinion shaft 28e are disposed in the differential casing 28b. The differential ring gear 28a is integrally connected to outside of the differential casing 28b. Each of the drive shafts 30 includes a spline engagement portion 30a and a bore fitting portion 30b.

The differential casing 28b is supported by the casing 18 via bearings so as to be rotatable about a rotation axis CL1 (hereinafter referred to as an axis CL1). The differential casing 28b is formed with bore portions 28b1 that are through-holes into which the drive shafts 30 are fitted so as to be relatively rotatable. The differential casing 28b is formed with shaft holes 28b2 that are through-holes into which the pinion shaft 28e is fitted so as not to be relatively rotatable. The differential casing 28b accommodates the side gears 28c, the differential pinions 28d and the like, and is a career of the differential gear device 28 into which the drive shafts 30 are fitted so as to be relatively rotatable.

The side gears 28c and the differential pinions 28d are internal gears 28 being of the differential gear device 28. The side gears 28c have through-holes in which the drive shafts 30 are fitted so as not to be relatively rotatable. Inner spline teeth are formed on inner circumferential surfaces 28c1 of the through-holes of the side gears 28c. The differential pinions 28d mesh with the side gears 28c. The differential pinions 28d are supported by the pinion shaft 28e so as to be relatively rotatable. The pinion shaft 28e is fitted in the shaft holes 28b2 and is fixed to the differential casing 28b.

The spline engagement portion 30a is located in at a differential-side end portion of each of the drive shafts 30, which is on side of the differential gear device 28. Outer spline teeth are formed on an outer circumferential surface of the spline engagement portion 30a of each of the drive shafts 30. When the spline engagement portion 30a of each of the drive shafts 30 is fitted in a corresponding one of the side gears 28c, each of the drive shafts 30 and a corresponding one of the side gears 28c are spline-engaged with each other so as not to be relatively rotatable. That is, each of the side gears 28c and a corresponding one of the drive shafts 30 are rotatable integrally around the axis CL1. The bore fitting portion 30b is located adjacent to the spline engagement portion 30a on side of the drive wheel 14. The bore fitting portion 30b of each of the drive shafts 30 is fitted in a corresponding one of the bore portions 28b1 of the differential casing 28b so as to be relatively rotatable.

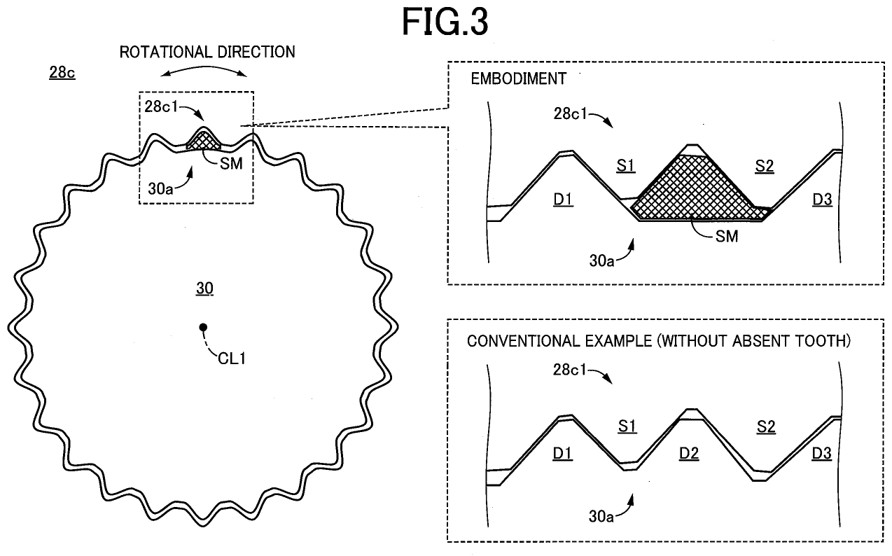

FIG. 3 is a set of views for explaining an example of the spline connection structure according to the present invention. Each of the views of FIG. 3 is a cross-sectional view of the connection state between the side gear 28c and the drive shaft 30, as viewed in a direction parallel to the axis CL1. As shown in FIG. 3, the inner circumferential surface 28cl of the side gear 28c and the spline engagement portion 30a of the drive shaft 30 are spline-engaged with each other. In FIG. 3, each of two views, which are located in a right-side portion of FIG. 3, shows, in enlargement, a spline-engaged state of a portion surrounded by a broken line in another view which is located in a left-side portion of FIG. 3. A lower one of the two views shows a conventional example in which the outer spline teeth without absent tooth (i.e., without any one of the outer spline teeth being absent) of the spline engagement portion 30a of the drive shaft 30 are shown, and teeth D1, D2 and D3 are ones of the outer spline teeth of the spline engagement portion 30a. A tooth S1, which is one of the inner spline teeth of the inner circumferential surface 28cl of the side gear 28c, is located between the teeth D1 and D2, and a tooth S2, which is another one of the inner spline teeth of the inner circumferential surface 28cl of the side gear 28c, is located between the teeth D2 and D3. In contrast to such a conventional example, in the present embodiment, as shown in an upper one of the above-described two views located in the right-side portion of FIG. 3, the tooth D2 is an absent tooth, namely, is absent, and a rod-shaped elastic body SM having spring characteristics is disposed in a longitudinal space that is formed by the absence of the tooth D2, preferably in a pressurized state. Elastic force of the rod-shaped elastic body SM, owing to the spring characteristics, serves to reduce backlash in the spline engagement, which is caused by gaps between the teeth S1, S2 on the inner circumferential surface 28c1 of the side gear 28c and the teeth D1, D3 of the spline engagement portion 30a of the drive shaft 30.

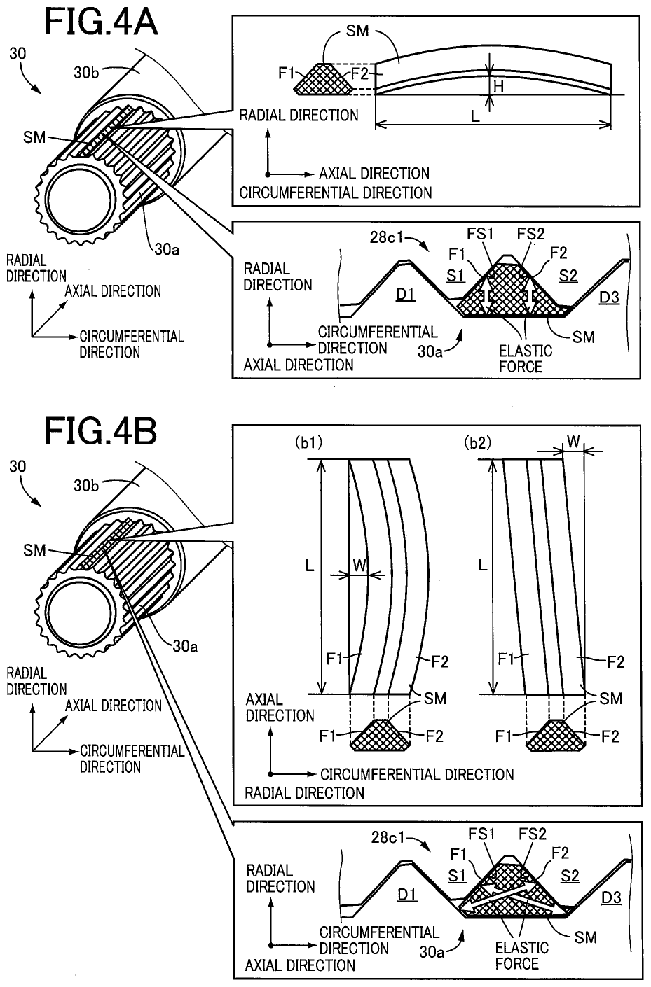

FIGS. 4A and 4B are views illustrating examples of the spring characteristics of rod-shaped elastic bodies SM. FIG. 4A is a set of views showing a case where the rod-shaped elastic body SM has spring characteristics in a radial direction of the drive shaft 30. One of the views, which is located in a left-side portion of FIG. 4A, is a perspective view of the drive shaft 30. As shown in another one of the views, which is located in an upper-right-side portion of FIG. 4A, when the rod-shaped elastic body SM is in its natural state, the elastic body SM is curved to have a displacement width H outward in the radial direction in its longitudinally central portion. Thus, in the natural state, the rod-shaped elastic body SM has a total length larger than a length L of the above-described longitudinal space, i.e., a length L of the spline engagement portion 30a. When the rod-shaped elastic body SM has been accommodated in the longitudinal space by being elastically deformed, the elastic body SM is given the spring characteristics returning the elastic body SM to the natural state from its accommodated posture. Therefore, as shown in still another one of the views, which is located in a lower-right-side portion of FIG. 4A, after the side gear 28c has been mounted on the drive shaft 30 with the inner spline teeth of the side gear 28c being engaged with the outer spline teeth of the drive shaft 30, elastic force (spring load) generated by elastic deformation of the rod-shaped elastic body SM is applied between an outer circumferential surface of the spline engagement portion 30a of the drive shaft 30 and tooth surfaces FS1, FS2 (that are exposed in the gap between the teeth S1, S2 on the inner circumferential surface 28c1 of the side gear 28c) in the radial direction that is indicated by white arrows, so as to reduce the backlash in the spline engagement. The rod-shaped elastic body SM has a triangular prismatic shape having a substantially triangular cross-sectional shape similar to the longitudinal space that is formed by absence of the tooth D2. The rod-shaped elastic body SM has a pair of inclined surfaces F1, F2 which are inclined to be parallel with the tooth surfaces FS1, FS2 of the teeth S1, S2, and which are opposed to the tooth surfaces FS1, FS2 of the teeth S1, S2. The inclined surfaces F1, F2 of the rod-shaped elastic body SM are in surface contact with the tooth surfaces FS1, FS2 of the teeth S1, S2, respectively. The surface contact reduces surface pressure applied to the rod-shaped elastic body SM, thereby making it possible to suppress wear and increase durability of the spline connection structure. The rod-shaped elastic body SM is preferably made of, for example, a metal spring material such as spring steel or a rubber-based material. The displacement width H and the spring characteristics (spring coefficient) are predetermined values, and are suitably obtained by design or experimentally.

FIG. 4B is a set of views showing a case where the rod-shaped elastic body SM has spring characteristics in a circumferential direction (rotational direction) of the drive shaft 30. One of the views, which is located in a left-side portion of FIG. 4B, is a perspective view of the drive shaft 30. As shown in another one (b1) of the views, which is located in an upper-right-side portion of FIG. 4B, when the rod-shaped elastic body SM is in its natural state, the elastic body SM is curved to have a displacement width W in the circumferential direction in its longitudinally central portion. Further, as shown in still another one (b2) of the views, which is also located in the upper-right-side portion of FIG. 4B, when the rod-shaped elastic body SM is in its natural state, the elastic body SM has a displacement width W in the circumferential direction in its longitudinal end portion. Thus, in the natural state, the rod-shaped elastic body SM has a total length larger than a length L of the above-described longitudinal space. When the rod-shaped elastic body SM has been accommodated in the longitudinal space by being elastically deformed, the elastic body SM is given the spring characteristics returning the elastic body SM to the natural state from its accommodated posture. Therefore, as shown in still another one of the views, which is located in a lower-right-side portion of FIG. 4B, after the side gear 28c has been mounted on the drive shaft 30 with the inner spline teeth of the side gear 28c being engaged with the outer spline teeth of the drive shaft 30, elastic force (spring load) generated by elastic deformation of the rod-shaped elastic body SM is applied to the teeth D1, D3 of the spline engagement portion 30a of the drive shaft 30 and the tooth surfaces FS1, FS2 (that are exposed in the gap between the teeth S1, S2 on the inner circumferential surface 28c1 of the side gear 28c) in the circumferential direction (rotational direction) that is indicated by white arrows, so as to reduce the backlash in the spline engagement. The material and shape (including the displacement width W) of the rod-shaped elastic body SM are suitably formed as in the case of FIG. 4A.

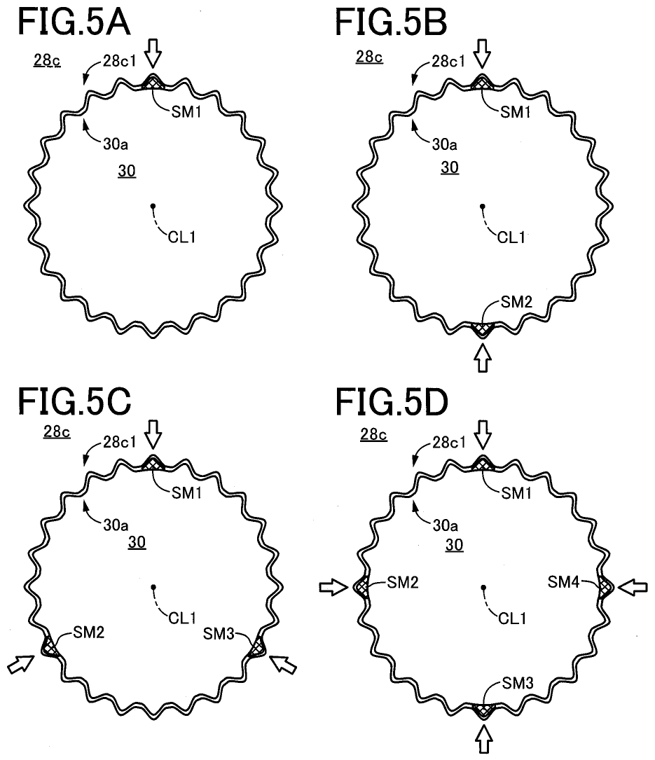

FIGS. 5A-5D are views for explaining examples of arrangement of the rod-shaped elastic bodies SM. FIG. 5A shows an arrangement in which one of the outer spline teeth of the drive shaft 30 is absent and the rod-shaped elastic body SM1 is provided in the longitudinal space that is formed by absence of the one of the outer spline teeth of the drive shaft 30. FIG. 5B shows an arrangement in which two of the outer spline teeth of the drive shaft 30 are absent and the two rod-shaped elastic bodies SM1, SM2 are provided in the two longitudinal spaces that are formed by absence of the two of the outer spline teeth of the drive shaft 30. FIG. 5C shows an arrangement in which three of the outer spline teeth of the drive shaft 30 are absent and the three rod-shaped elastic bodies SM1, SM2, SM3 are provided in the three longitudinal spaces that are formed by absence of the three of the outer spline teeth of the drive shaft 30. FIG. 5D shows an arrangement in which four of the outer spline teeth of the drive shaft 30 are absent and the four rod-shaped elastic bodies SM1, SM2, SM3, SM4 are provided in the four longitudinal spaces that are formed by absence of the four of the outer spline teeth of the drive shaft 30. As shown in FIGS. 5B-5D, in the arrangements in which the two or more rod-shaped elastic bodies SM are provided in the two or more longitudinal spaces, the rod-shaped elastic bodies SM are spaced substantially at a constant interval in the circumferential direction. Accordingly, the elastic forces (spring loads) of the rod-shaped elastic bodies SM are balanced, so that centering of rotational axes of the side gear 28c and the drive shaft 30 with respect to the axis CL1 is performed, and backlash of the spline engagement is more efficiently reduced or eliminated.

### Second Embodiment

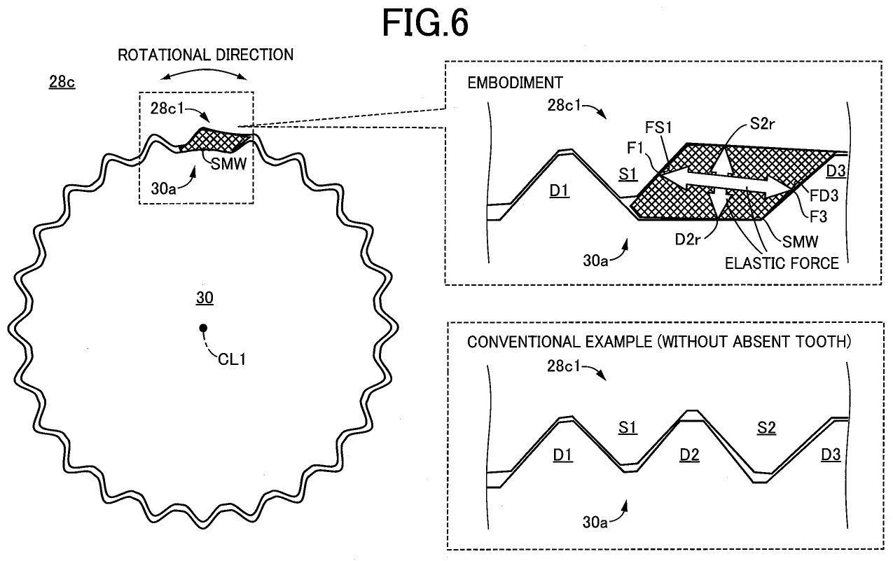

FIG. 6 is a set of views for explaining another embodiment of the spline connection structure to which the present invention is applied. Each of the views of FIG. 6 is a cross-sectional view of the connection state between the side gear 28c and the drive shaft 30, as viewed in a direction parallel to the axis CL1. As shown in FIG. 6, the inner circumferential surface 28c1 of the side gear 28c and the spline engagement portion 30a of the drive shaft 30 are spline-engaged with each other. In FIG. 6, each of two views, which are located in a right-side portion of FIG. 6, shows, in enlargement, a spline-engaged state of a portion surrounded by a broken line in another view which is located in a left-side portion of FIG. 6. A lower one of the two views shows a conventional example in which the outer and inner spline teeth without absent tooth (i.e., without any one of the outer and inner spline teeth being absent) are shown, and teeth D1, D2 and D3 are ones of the outer spline teeth of the spline engagement portion 30a. A tooth S1, which is one of the inner spline teeth of the inner circumferential surface 28c1 of the side gear 28c, is located between the teeth D1 and D2, and a tooth S2, which is another one of the inner spline teeth of the inner circumferential surface 28cl of the side gear 28c, is located between the teeth D2 and D3. In contrast to such a conventional example, in the present embodiment, as shown in an upper one of the above-described two views located in the right-side portion of FIG. 6, the tooth S2 as well as the tooth D2 is an absent tooth, namely, is absent, and a rod-shaped elastic body SMW having spring characteristics is disposed in a longitudinal space that is formed by absence of the tooth D2 and tooth S2, preferably in a pressurized state. The rod-shaped elastic body SMW has a square prismatic shape having a substantially parallelogram cross-sectional shape similar to the longitudinal space that is formed by absence of the tooth D2 and tooth S2. The rod-shaped elastic body SMW is formed to have spring characteristics in the radial direction or the circumferential direction (rotational direction) like the rod-shaped elastic body SM in the above-described first embodiment. Further, the rod-shaped elastic body SMW is preferably made of, for example, a metal spring material such as spring steel or a rubber-based material, like the rod-shaped elastic body SM in the above-described first embodiment. Where the rod-shaped elastic body SMW has the spring characteristics in the radial direction, the elastic force (spring load) of the rod-shaped elastic body SMW is applied in the radial direction between a tooth-absent portion S2r of the inner circumferential surface 28c1 of the side gear 28c and a tooth-absent portion D2r of the spline engagement portion 30a of the drive shaft 30. Where the rod-shaped elastic body SMW has the spring characteristic in the circumferential direction (rotational direction), the elastic force (spring load) of the rod-shaped elastic body SMW is applied in the circumferential direction (rotational direction) between the tooth surface FS1 (exposed in the gap of the tooth S1 of the inner circumferential surface 28c1 of the side gear 28c) and the tooth surface FD3 (exposed in the gap of the tooth D3 of the spline engagement portion 30a of the drive shaft 30) (see white arrows). As indicated by the white arrows in the drawing, the elastic force (spring load) of the rod-shaped elastic body SMW acts directly between the tooth-absent portions S2r and D2r or between the tooth surface FS1 of the tooth S1 and the tooth surface FD3 of the tooth D3, namely, between the inner circumferential surface 28c1 of the side gear 28c and the spline engagement portion 30a of the drive shaft 30, so that it is possible to efficiently eliminate or reduce the backlash of the spline engagement that is due to the gaps between the inner spline teeth of the inner circumferential surface 28c1 of the side gear 28c and the outer spline teeth of the spline engagement portion 30a of the drive shaft 30. The rod-shaped elastic body SMW has a pair of inclined surfaces F1, F3 which are inclined to be parallel with the tooth surfaces FS1, FD3 of the teeth S1, D3, and which are opposed to the tooth surfaces FS1, FD3 of the teeth S1, D3. The inclined surfaces F1, F3 of the rod-shaped elastic body SMW are in surface contact with the tooth surfaces FS1, FD3 of the teeth S1, D3, respectively. The surface contact reduces surface pressure applied to the rod-shaped elastic body SMW, thereby making it possible to suppress wear and increase durability of the spline connection structure.

Further, in the arrangements in which the two or more rod-shaped elastic bodies SMW are provided in the two or more longitudinal spaces, the rod-shaped elastic bodies SMW are spaced substantially at a constant interval in the circumferential direction, as in the arrangements of the above-described first embodiment that are shown in FIGS. 5B-5D. Accordingly, the elastic forces (spring loads) of the rod-shaped elastic bodies SMW are balanced, so that centering of rotational axes of the side gear 28c and the drive shaft 30 with respect to the axis CL1 is performed, and backlash of the spline engagement is more efficiently reduced or eliminated.

As described above, in the spline connection structure according to the first and second embodiments, the at least one of the outer spline teeth of the spline engagement portion 30a of the drive shaft 30 is absent, and the rod-shaped elastic body SM, SMW having the spring characteristics in the radial direction or the circumferential direction is provided in the longitudinal space that is formed by absence of each of the at least one of the outer spline teeth of the drive shaft 30. Thus, the backlash of the spline engagement between the inner spline teeth of the side gear 28c and the outer spline teeth of the drive shaft 30 is eliminated or reduced by elastic force based on the spring characteristics of the rod-shaped elastic body SM, SMW, wherein the elastic force acts in the radial direction or the circumferential direction. Therefore, it is possible to obtain the spline connection structure having high durability and capable of reducing the backlash in its spline engagement.

Further, in the spline connection structure according to the first and second embodiments, where the two or more rod-shaped elastic bodies SM, SMW provided in the two or more longitudinal spaces, the rod-shaped elastic bodies SM, SMW are spaced substantially at the constant interval in the circumferential direction. Accordingly, the elastic forces (spring loads) of the rod-shaped elastic bodies SM, SMW are balanced, so that centering of rotational axes of the side gear 28c and the drive shaft 30 with respect to the axis CL1 is performed, and backlash of the spline engagement is more efficiently reduced or eliminated.

Further, in the spline connection structure according to the second embodiment, at least one of the inner spline teeth of the side gear 28c is absent, such that each of the at least one of the inner spline teeth of the side gear 28c is adjacent to a corresponding one of the at least one of the outer spline teeth of the drive shaft 30 in the circumferential direction, and the rod-shaped elastic body SMW is provided in the longitudinal space that is formed by cooperation of absence of the each of the at least one of the inner spline teeth of the side gear 28c and absence of the corresponding one of the at least one of the outer spline teeth of the drive shaft 30. Thus, the elastic force (spring load) of the rod-shaped elastic body SMW acts directly between the inner circumferential surface 28c1 of the side gear 28c and the spline engagement portion 30a of the drive shaft 30 that are in contact with the rod-shaped elastic body SMW, so that it is possible to efficiently eliminate or reduce the backlash of the spline engagement that is due to the gaps between the inner spline teeth of the inner circumferential surface 28cl of the side gear 28c and the outer spline teeth of the spline engagement portion 30a of the drive shaft 30.

Further, in the spline connection structure according to the first embodiment, the inner spline teeth of the side gear 28c have the exposed tooth surfaces FS1, FS2 that are exposed in the longitudinal space, and the rod-shaped elastic body SM has the pair of inclined surfaces F1, F2 which are opposed to the exposed tooth surfaces FS1, FS2 and which are held in surface contact with the exposed tooth surfaces FS1, FS2. In the spline connection structure according to the second embodiment, the inner spline teeth of the side gear 28c and the outer spline teeth of the drive shaft 30 have the exposed tooth surfaces FS1, FD3 that are exposed in the longitudinal space, and the rod-shaped elastic body SMW has the pair of inclined surfaces F1, F3 which are opposed to the exposed tooth surfaces FS1, FD3 and which are held in surface contact with the exposed tooth surfaces FS1,FD3. Thus, in the first and second embodiments, the surface contact reduces surface pressure applied to the rod-shaped elastic body SM, SMW, thereby making it possible to suppress wear and increase durability of the spline connection structure. Therefore, it is possible to obtain the spline connection structure having high durability and capable of reducing the backlash in its spline engagement.

Further, in the first and second embodiments, in the process of connecting between the drive shaft 30 and the side gear 28c of the differential gear device 28 by the spline connection structure, the rod-shaped elastic body SM, SMW having the total length larger than the length L of the longitudinal space is accommodated into the longitudinal space, by elastically deforming the rod-shaped elastic body SM, SMW, such that, after the side gear 28c has been mounted on the drive shaft 30 with the inner spline teeth of the side gear 28c being engaged with the outer spline teeth of the drive shaft 30, the elastic force generated by elastic deformation of the rod-shaped elastic body SM; SMW is applied to the drive shaft 30 and the side gear 28c, so as to reduce backlash between the drive shaft 30 and the side gear 28c.

Although the embodiments of the present invention have been described in detail with reference to the drawings, the above description is merely an embodiment, and the present invention can be implemented in various modified and improved forms based on the knowledge of those skilled in the art.

### NOMENCLATURE OF ELEMENTS

28: differential gear device
28c: side gear
28c1: inner circumferential surface
30: drive shaft
30a: spline engagement portion
F1: inclined surface
F2: inclined surface
F3: inclined surface
FD3: tooth surface
FS1: tooth surface
FS2: tooth surface
SM: rod-shaped elastic body
SMW: rod-shaped elastic body

What is claimed is:

1. A spline connection structure for connecting between a drive shaft and a side gear of a differential gear device through spline engagement,
the spline connection structure comprising:
outer spline teeth provided on an outer circumferential surface of the drive shaft; and
inner spline teeth provided on an inner circumferential surface of the side gear,
wherein at least one of the outer spline teeth of the drive shaft is absent,
the spline connection structure further comprising:
a rod-shaped elastic body provided in a longitudinal space that is formed by absence of each of the at least one of the outer spline teeth of the drive shaft.

2. The spline connection structure according to claim 1,
wherein the rod-shaped elastic body, which is provided in the longitudinal space that is formed by absence of each of the at least one of the outer spline teeth of the drive shaft, has spring characteristics in a radial direction or a circumferential direction of the drive shaft.

3. The spline connection structure according to claim 1,
wherein the at least one of the outer spline teeth of the drive shaft consists of a plurality of the outer spline teeth that are spaced substantially at a constant interval in a circumferential direction of the drive shaft, and
wherein the rod-shaped elastic body is provided in the longitudinal space that is formed by absence of each of the plurality of the outer spline teeth.

4. The spline connection structure according to claim 1,
wherein at least one of the inner spline teeth of the side gear is absent, such that each of the at least one of the inner spline teeth of the side gear is adjacent to a corresponding one of the at least one of the outer spline teeth of the drive shaft in a circumferential direction of the drive shaft, and
wherein the rod-shaped elastic body is provided in the longitudinal space that is formed by cooperation of absence of the each of the at least one of the inner spline teeth of the side gear and absence of the corresponding one of the at least one of the outer spline teeth of the drive shaft.

5. The spline connection structure according to claim 1,
wherein the inner spline teeth of the side gear have exposed tooth surfaces that are exposed in the longitudinal space, and
wherein the rod-shaped elastic body has a pair of inclined surfaces which are opposed to the exposed tooth surfaces and which are held in surface contact with the exposed tooth surfaces.

6. The spline connection structure according to claim 4,
wherein the inner spline teeth of the side gear and the outer spline teeth of the drive shaft have exposed tooth surfaces that are exposed in the longitudinal space, and
wherein the rod-shaped elastic body has a pair of inclined surfaces which are opposed to the exposed tooth surfaces and which are held in surface contact with the exposed tooth surfaces.

7. A process of connecting between a drive shaft and a side gear of a differential gear device by the spline connection structure according to claim 1,
the process comprising:
accommodating the rod-shaped elastic body, which has a total length larger than a length of the longitudinal space, into the longitudinal space, by elastically deforming the rod-shaped elastic body, such that, after the side gear has been mounted on the drive shaft with the inner spline teeth of the side gear being engaged with the outer spline teeth of the drive shaft, elastic force generated by elastic deformation of the rod-shaped elastic body is applied to the drive shaft and the side gear, so as to reduce backlash between the drive shaft and the side gear.
